(19) United States
(12) Patent Application Publication
(10) Pub. No.: US 2016/0085067 A1
(43) Pub. Date: Mar. 24, 2016

(54) HIGH POWER HANDLING OPTICAL SPATIAL LIGHT MODULATOR

(71) Applicant: SILICON LIGHT MACHINES CORPORATION, Sunnyvale, CA (US)

(72) Inventors: Alexander Payne, Ben Lomond, CA (US); James Hunter, Campbell, CA (US); Lars Eng, Los Altos, CA (US)

(21) Appl. No.: 14/673,276

(22) Filed: Mar. 30, 2015

Related U.S. Application Data
(60) Provisional application No. 62/053,738, filed on Sep. 22, 2014.

(51) Int. Cl. G02B 26/08; B23K 26/06

(52) U.S. Cl. CPC G02B 26/0841; B23K 26/0643

(57) ABSTRACT

Laser-based material processing systems including a Micro-Electromechanical System devices (MEMs) based reflective, optical modulator with dielectric mirrors for high power handling and methods of manufacturing and using the same are described. Generally, the system includes a workpiece support, a laser, a workpiece support, a laser, a MEMs based reflective, optical modulator to modulate a beam generated by the laser; and imaging optics to direct modulated light from the optical modulator onto a workpiece on the workpiece support. The optical modulator includes a number of surfaces with dielectric mirrors formed thereon to modulate the beam generated by the laser. Other embodiments are also described.

### CROSS-REFERENCE TO RELATED APPLICATIONS

The present application claims the benefit of priority under 35 U.S.C. 119(e) to U.S. Provisional Patent Application Ser. No. 61/201,887, entitled “HIGH POWER HANDLING OPTICAL SPATIAL LIGHT MODULATOR,” filed Sep. 22, 2014, which application is hereby incorporated by reference in its entirety.

### TECHNICAL FIELD

The present invention relates generally to a Micro-Electromechanical System devices (MEMs) based optical modulators with dielectric mirrors for high power handling and to methods of manufacturing and using the same.

### BACKGROUND

Laser processing systems are widely used and growing in popularity for a number of different applications including cutting, marking, engraving, printing, testing and measuring. For example, laser engraving and imaging systems are used to form designs, such as text, logos, or other ornamental designs, on and/or in workpieces. Current state-of-art laser processing systems use a high power laser and a galvo-scan mirror to scan a single beam over a metal, plastic, wood or paper workpiece to form a design. Because of this the time required to form a design on a single workpiece using a conventional laser processing system is unacceptably long. Moreover, because in many conventional systems the workpiece is moved relative to the single laser beam the resolution and complexity of the design can be adversely affected.

Although faster MEMs based SLM with greater resolution exist, these conventional MEMs based SLMs cannot handle the high power lasers employed in laser processing systems. Typically, the failure mode of these devices when exposed to high power or temperature lasers is the “Soret effect” in which atoms of a reflective metal, such as aluminum, covering reflective surfaces in the MEMs based SLM physically migrate along from a hotter to a cooler region of the ribbon. This migration of metal atoms can reduce the reflection and hence the efficiency of the SLM, and ultimately shortens useful device life.

Accordingly, there is a need for a faster, higher resolution laser processing system capable of handling a beam generated by a high power laser.

### SUMMARY

In a first aspect a laser processing system is provided including a Micro-Electromechanical System (MEMs) device based reflective, optical modulator with dielectric mirrors for high power handling. Generally, the system includes a workpiece support, a laser, a workpiece support, a laser, a MEMs based reflective, optical modulator to modulate a beam generated by the laser; and imaging optics to direct modulated light from the optical modulator onto a workpiece on the workpiece support. The optical modulator includes a number of surfaces with dielectric mirrors formed thereon to modulate the beam generated by the laser. Other embodiments are also described. In one embodiment, the dielectric mirrors comprise Bragg mirrors including a stack of layers having different optical characteristics.

In a second aspect, a method for processing a workpiece using a system including a MEMs based optical modulator ganged together to create a high powered spatial light modulator (SLM) is provided. Generally, the method includes or involves: (i) positioning the workpiece on a workpiece support; (ii) directing light from a laser onto reflective surfaces of the MEMs based optical modulators, wherein the reflective surfaces include dielectric mirrors or reflectors; (iii) modulating with the MEMs based optical modulators light reflected from the reflective surfaces thereof; and (iv) irradiating at least a portion of a workpiece with the modulated light. Processes performed on the workpiece can include, for example, sintering or ablating the workpiece.

### BRIEF DESCRIPTION OF THE DRAWINGS

Embodiments of the present invention will be understood more fully from the detailed description that follows and from the accompanying drawings and the appended claims provided below, where:

FIG. 1A is a perspective view of an embodiment of a Micro-Electromechanical System devices (MEMs) based optical modulator according to an embodiment of the present disclosure;

FIGS. 1B and 1C schematic block diagrams of sectional side views of the MEMs based optical modulator of FIG. 1A;

FIG. 2A is a schematic block diagram of another embodiment of a MEMs based optical modulator according to an embodiment of the present disclosure;

FIG. 2B is a schematic sectional side view of two adjacent modulators of the array of FIG. 2A;

FIG. 2C is a schematic block diagram of an actuator of a single modulator of the array of FIG. 2A;

FIG. 3 is a schematic block diagram of a planar top view of a planar light valve (PLV™) in which the dielectric mirrors or reflectors are decoupled or mechanically isolated from the MEMS of the PLV™;

FIG. 4 is a schematic sectional side view of a stack of layers in a distributed or Bragg dielectric mirrors for use in the MEMs based optical modulator of FIGS. 1 through 3;

FIG. 5 is a graph illustrating the reflection, transmission and absorption of a distributed or Bragg dielectric mirror including alternating layers of polysilicon, silicon-dioxide and polysilicon at a near infrared (NIR) wavelength of 800 nanometers (nm);

FIG. 6 is a table giving the lowest absorption (k), and greatest index difference (n) and percent reflectance of different materials for use in a distributed or Bragg dielectric mirror in the ultraviolet (UV), visible (VIS) and near infrared (NIR) wavelengths;

FIG. 7 is a graph illustrating the reflection, transmission and absorption of a silicon-nitride/silicon-dioxide distributed or Bragg dielectric mirror in the ultraviolet (UV) wavelengths;

FIG. 8 is a graph illustrating the reflection, transmission and absorption of a zirconium-oxide/silicon-dioxide distributed or Bragg dielectric mirror in the ultraviolet (UV) wavelengths;

FIG. 9 is a graph illustrating the reflection, transmission and absorption of a silicon-carbide/silicon-dioxide distributed or Bragg dielectric mirror in the ultraviolet (UV) wavelengths;

FIG. 10 is a graph illustrating the reflection, transmission and absorption of a silicon-nitride/silicon-dioxide distributed or Bragg dielectric mirror in the visible (VIS) wavelengths;

FIG. 11 is a graph illustrating the reflection, transmission and absorption of a silicon-carbide/silicon-dioxide distributed or Bragg dielectric mirror in the visible (VIS) wavelengths;

FIG. 12 is a graph illustrating the reflection, transmission and absorption of a titanium-oxide/silicon-dioxide distributed or Bragg dielectric mirror in the visible (VIS) wavelengths;

FIG. 13 is a graph illustrating the reflection, transmission and absorption of an aluminum-arsenide/silicon-dioxide distributed or Bragg dielectric mirror in the visible (VIS) wavelengths;

FIG. 14 is a graph illustrating the reflection, transmission and absorption of a titanium-oxide/silicon-dioxide distributed or Bragg dielectric mirror in the near infrared (NIR) wavelengths;

FIG. 15 is a graph illustrating the reflection, transmission and absorption of an aluminum-arsenide/silicon-dioxide distributed or Bragg dielectric mirror in the near infrared (NIR) wavelengths;

FIG. 16 is a graph illustrating the reflection, transmission and absorption of a polysilicon/silicon-dioxide distributed or Bragg dielectric mirror in the near infrared (NIR) wavelengths and having a thickness of 4480 angstroms (Å);

FIG. 17 is a graph illustrating the reflection, transmission and absorption of a polysilicon/silicon-dioxide distributed or Bragg dielectric mirror in the near infrared (NIR) wavelengths and having a thickness of 2500 Å;

FIG. 18 is a schematic block diagram of an embodiment of a laser processing system including a spatial light modulators (SLM) comprising an array of optical modulators with dielectric mirrors for high power handling according to an embodiment of the present disclosure;

FIG. 19 is a schematic block diagram of another embodiment of a laser processing system using phase modulation and including a SLM comprising an array of optical modulators with dielectric mirrors for high power handling according to an embodiment of the present disclosure; and

FIG. 20 is a flowchart illustrating an embodiment of a method for processing a workpiece using the laser processing systems of FIG. 18 or 19.

### DETAILED DESCRIPTION

Embodiments of laser processing systems including a Micro-Electromechanical System devices (MEMs) based optical switch or optical modulator with dielectric mirrors for high power handling and to methods of manufacturing and using the same are described herein with reference to figures. However, particular embodiments may be practiced without one or more of these specific details, or in combination with other known methods, materials, and apparatuses. In the following description, numerous specific details are set forth, such as specific materials, dimensions and processes parameters etc. to provide a thorough understanding of the present invention. In other instances, well-known semiconductor design and fabrication techniques have not been described in particular detail to avoid unnecessarily obscuring the present invention. Reference throughout this specification to “an embodiment” means that a particular feature, structure, material, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, materials, or characteristics may be combined in any suitable manner in one or more embodiments.

The terms “over,” “under,” “between,” and “on” as used herein refer to a relative position of one layer with respect to other layers. As such, for example, one layer deposited or disposed over or under another layer may be directly in contact with the other layer or may have one or more intervening layers. Moreover, one layer deposited or disposed between layers may be directly in contact with the layers or may have one or more intervening layers. In contrast, a first layer “on” a second layer is in contact with that second layer. Additionally, the relative position of one layer with respect to other layers is provided assuming operations deposit, modify and remove films relative to a starting substrate without consideration of the absolute orientation of the substrate.

The optical modulator can be either an optical switch in which a movable member of the modulator is switched between a reflective and a non-reflective state, or an optical modulator with gray scale capability in which either the phase or intensity of light reflected from the optical modulator is modulated.

Furthermore, the optical modulator can include either a single, individual pixel or multiple pixels ganged together in a one-dimensional (1D or two-dimensional (2-D) array to create a high power spatial light modulator (SLM). Suitable optical modulators include a ribbon-type optical modulator, such as a Grating Light Valve (GLV™), or a planar light valve (PLV™), from Silicon Light Machines, Inc., of Sunnyvale, Calif.

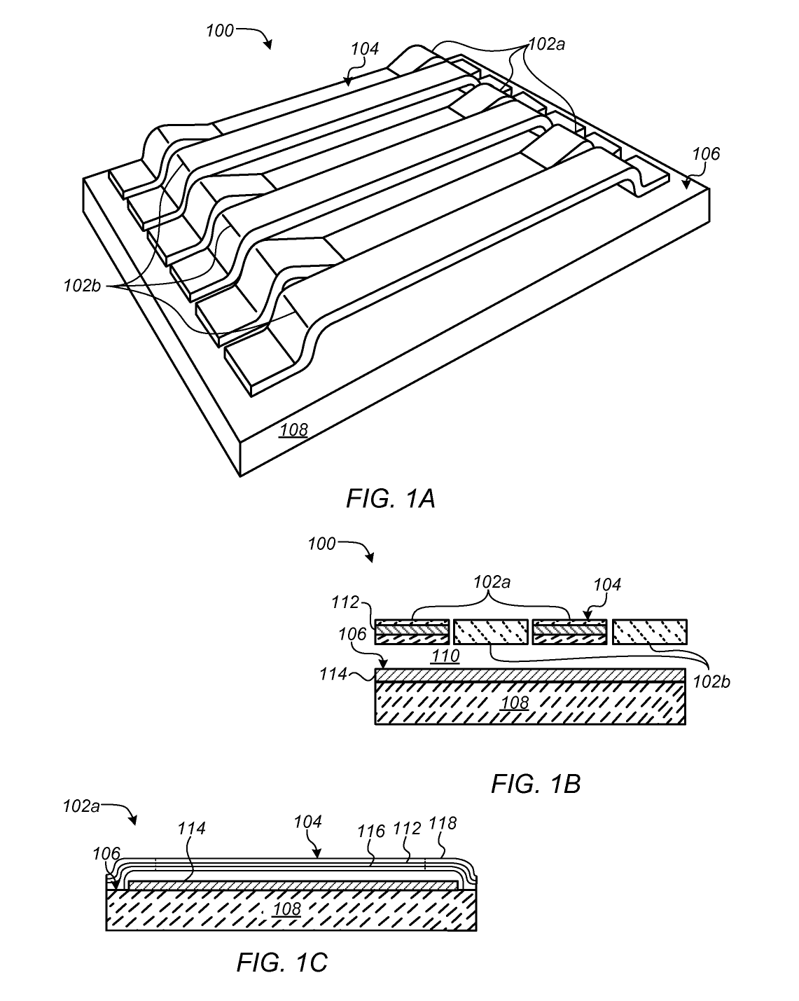

A ribbon-type optical modulator, such as a GLV™, including a number of dielectric mirrors or reflectors formed thereon to modulate a beam of light generated by a laser will now be described with reference to FIG. 1. For purposes of clarity, many of the details of MEMS in general and MEMS optical modulators in particular that are widely known and are not relevant to the present invention have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

Referring to FIGS. 1A and 1B, a ribbon-type optical modulator 100 generally includes a number of ribbons 102a, 102b; each having a light reflective surface 104 supported over a surface 106 of a substrate 108. One or more of the ribbons 102a are movable or deflectable through a gap or cavity 110 toward the substrate 108 to form an addressable diffraction grating with adjustable diffraction strength. The ribbons are 102a deflected towards the surface 106 of the substrate 108 by electrostatic forces generated when a voltage is applied between electrodes 112 in the deflectable ribbons 102a and base electrodes 114 formed in or on the substrate. The applied voltages are controlled by drive electronics (not shown in these figures), which may be integrally formed in or on the surface 106 of the substrate 108 below or adjacent to the ribbons 102. Light reflected from the movable ribbons 102a adds as vectors of magnitude and phase with that reflected from stationary ribbons 102b or a reflective portion of the surface 106 beneath the ribbons, thereby modulating light reflected from the optical modulator 100.

A schematic sectional side view of a movable structure or ribbon 102a of the optical modulator 100 of FIG. 1A taken along a longitudinal axis is shown in FIG. 1C. Referring to FIG. 1C, the ribbon 102a includes an elastic mechanical layer 116 to support the ribbon above the surface 106 of the substrate 108, an electrode or conducting layer 112 and a reflective surface 104 overlying the mechanical layer and conducting layer. As shown in FIG. 1C, the reflective surface 104 is formed on a separate dielectric mirror or reflector 118 discrete from and overlying the mechanical layer 116 and the conducting layer 112.

Generally, the mechanical layer 116 comprises a taut silicon-nitride film (SiNx), and flexibly supported above the surface 106 of the substrate 108 by a number of posts or structures, typically also made of SiNx, at both ends of the ribbon 102a. The conducting layer 112 can be formed over and in direct physical contact with the mechanical layer 116, as shown, or underneath the mechanical layer. The conducting layer 112 or ribbon electrode can include any suitable conducting or semiconducting material compatible with standard MEMS fabrication technologies. For example, the conducting layer 112 can include an amorphous or polycrystalline silicon (poly) layer, or a titanium-nitride (TiN) layer. Alternatively, if the reflective layer 118 is above the conductive layer 112, the conductive layer could also be metallic.

The separate, discrete reflecting layer 118, where included, can include any suitable metallic, dielectric or semiconducting material compatible with standard MEMS fabrication technologies, and capable of being patterned using standard lithographic techniques to form the reflective surface 104.

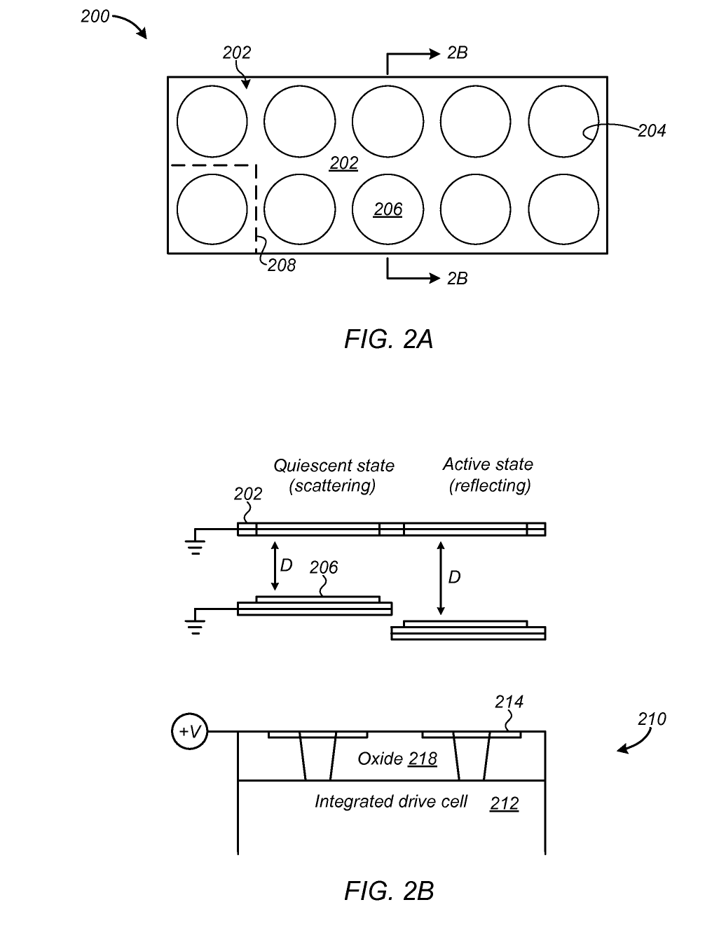

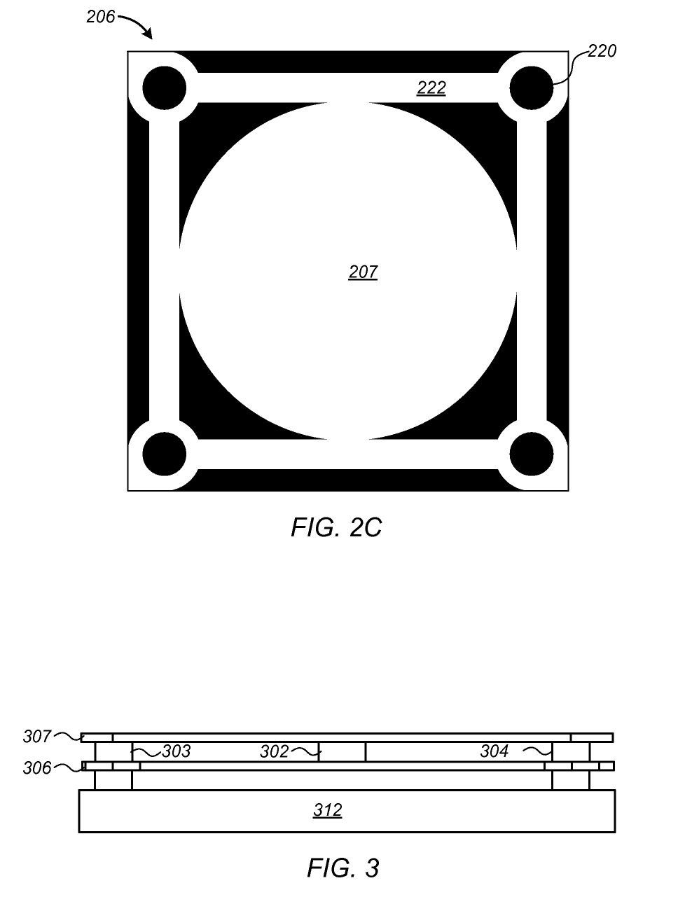

Another type of MEMS based optical modulator for which the dielectric mirror of the present invention is particularly useful is a planar light valve or PLV™ from Silicon Light Machines, Inc., of Sunnyvale, Calif. Referring to FIGS. 2A through 2D, a planar type light valve or PLV™ 200 generally includes two films or membranes having light reflecting surfaces of equal area and reflectivity disposed above an upper surface of a substrate (not shown in this figure). The topmost film is a static tent membrane or member 202 of a uniform, planar sheet of a material having a first planar light reflective dielectric mirror or reflector 203, for example taut silicon-nitride covered on a top surface with one or more layers of material reflective to at least some of the wavelengths of light incident thereon. The face plate 202 has an array of apertures 204 extending from the top dielectric mirror 203 of the member to a lower surface (not shown). The face plate 202 covers an actuator membrane underneath. The actuator membrane includes a number of flat, displaceable or movable actuators 206. The actuators 206 have second planar dielectric mirror or reflector 207 parallel to the first planar dielectric mirror 203 of the face plate 202 and positioned relative to the apertures 204 to receive light passing therethrough. Each of the actuators 206, the associated apertures 204 and a portion of the face plate 202 immediately adjacent to and enclosing the aperture form a single, individual modulator 208 or diffractor. The size and position of each of the apertures 204 are chosen to satisfy an “equal reflectivity” constraint. That is the area of the second dielectric mirror 207 exposed by a single aperture 204 inside is substantially equal to the reflectivity of the area of the individual modulator 208 outside the aperture 204.

FIG. 2B depicts a cross-section through two adjacent modulators 208 of the light valve 200 of FIG. 2A. In this exemplary embodiment, the upper face plate 202 remains static, while the lower actuator membrane or actuators 206 move under electrostatic forces from integrated electronics or drive circuitry in the substrate 210. The drive circuitry generally includes an integrated drive cell 212 coupled to substrate or drive electrodes 214 via interconnect 216. An oxide 218 may be used to electrically isolate the electrodes 214. The drive circuitry is configured to generate an electrostatic force between each electrode 214 and its corresponding actuator 206.

Individual actuators 206 or groups of actuators are moved up or down over a very small distance (typically only a fraction of the wavelength of light incident on the light valve 200) relative to first planar dielectric mirror 203 of the face plate 202 by electrostatic forces controlled by drive electrodes 214 in the substrate 210 underlying the actuators 206. Preferably, the actuators 206 can be displaced by n*λ/4 wavelength, where λ is a particular wavelength of light incident on the first and second planar dielectric mirrors 203, 207, and n is an integer equal to or greater than 0. Moving the actuators 206 brings reflected light from the second planar dielectric mirror 207 into constructive or destructive interference with light reflected by the first planar dielectric mirror 203 (i.e., the face plate 202), thereby modulating light incident on the light valve 200.

For example, in one embodiment of the light valve 200 shown in FIG. 2B, the distance (D) between reflective layers of the tent 202 and actuator 206 may be chosen such that, in a non-deflected or quiescent state, the face plate, or more accurately the first dielectric mirror 203, and the actuator (second dielectric mirror 207), are displaced from one another by an odd multiple of λ/4, for a particular wavelength λ of light incident on the light valve 200. This causes the light valve 200 in the quiescent state to scatter incident light, as illustrated by the left actuator of FIG. 2B. In an active state for the light valve 200, as illustrated by the right actuator of FIG. 2B, the actuator 206 may be displaced such that the distance between the dielectric mirrors 203, 207 of the face plate 202 and the actuator 206 is an even multiple of λ/4 causing the light valve 200 to reflect incident light.

In an alternative embodiment, not shown, the distance (D) between reflective layers of the tent 202 and actuator 206 can be chosen such that, in the actuator's quiescent state, the first and second dielectric mirrors 203, 207 are displaced from one another by an even multiple of λ/4, such that the light valve 200 in quiescent state is reflecting, and in an active state, as illustrated by the right actuator, the actuator is displaced by an odd multiple of λ/4 causing it to scatter incident light.

The size and position of each of the apertures 204 are predetermined to satisfy the “equal reflectivity” constraint. That is the reflectivity of the area of a single aperture 204 inside is equal to the reflectivity of the remaining area of the cell that is outside the aperture 204.

A close up planar view of a single actuator is shown in FIG. 2C. Referring to FIG. 2C, the actuator 206 is anchored or posted to the underlying substrate (not shown in this figure) by a number of posts 220 at the corner of each actuator. The actuators 208 include uniform, planar disks each having a planar dielectric mirror 207 and flexibly coupled by hinges or flexures 222 of an elastic material to one or more of the posts 220.

A schematic block diagram of a sectional side view of the actuator 206 of FIG. 2C is shown in FIG. 2D. Referring to FIG. 2D, the actuator 206 includes an elastic mechanical (SiN) layer 224 that flexibly couples discs of the actuator to the posts 220, an electrically conductive layer 226, such as a titanium-nitride (TiN) layer, and a reflective layer 228 overlying the conducting layer. The dielectric mirrors 207 of the actuators 206 can also include one or more layers of material reflective to at least some of the wavelengths of light incident thereon.

Although the light reflective surface of the actuator 206 is shown and described above as being positioned below the light reflective surface 203 of the face plate 202 and between the first reflective surface and the upper surface of the substrate, it will be appreciated that the dielectric mirror 207 of the actuator can alternatively be raised above the movable actuator so as to be positioned coplanar with or above the light reflective surface of the face plate 202.

In an alternative embodiment, shown in FIG. 3, the dielectric mirrors or reflectors 307 of the actuators 306 are decoupled or mechanically isolated or separated from the taut silicon nitride of the MEMS of the PLV 300 which governs drive voltage by a center support 302 and one or more posts 304 at the corners of the individual modulator 308.

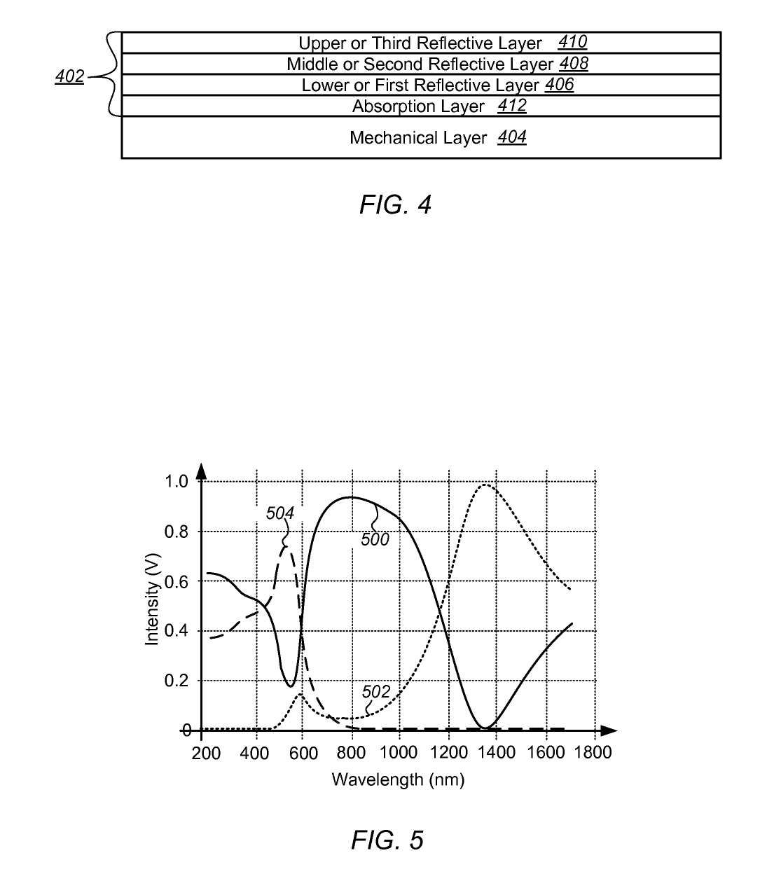

In an alternative embodiment, shown in FIG. 4, the dielectric mirrors or reflectors are distributed or Bragg mirrors including a stack of layers having different optical characteristics or properties, such as reflection, transmission and absorption. Referring to FIG. 4, in one embodiment the dielectric mirror 402 includes a first or lower reflective layer 406 overlying the mechanical layer 404 of the MEMs based optical modulator, a second or middle reflective layer 408 on the first or lower reflective layer, and a third or top reflective layer 410 on the second or middle reflective layer. Optionally, in certain embodiments, such as that shown in FIG. 4, the dielectric mirror 402 further includes an absorption layer 412 to prevent residual light from being transmitted to underlying regions. Suitable materials for the reflecting layers can include polysilicon, silicon-oxide, titanium oxide, silicon-carbide, aluminum-arsenide, Zirconium oxide and Titanium dioxide. Suitable materials for the absorption layer 412 can include doped semiconductors or thermally compatible metallic films.

A graph illustrating the reflection 500, transmission 502 and absorption 504 of a distributed or Bragg dielectric mirror including alternating layers of polysilicon, silicon-dioxide and polysilicon at near infrared (NIR) wavelengths is shown in FIG. 5. Referring to FIG. 5 it is seen that a distributed or Bragg dielectric mirror including a first reflective layer of 56 nanometers (nm) polysilicon, a second reflective layer of 68 nm silicon-dioxide and a top reflective layer of 56 nm polysilicon, a second reflective layer of 68 nm silicon-dioxide exhibits a total reflection of about 95% at or near a center wavelength of 800 nm.

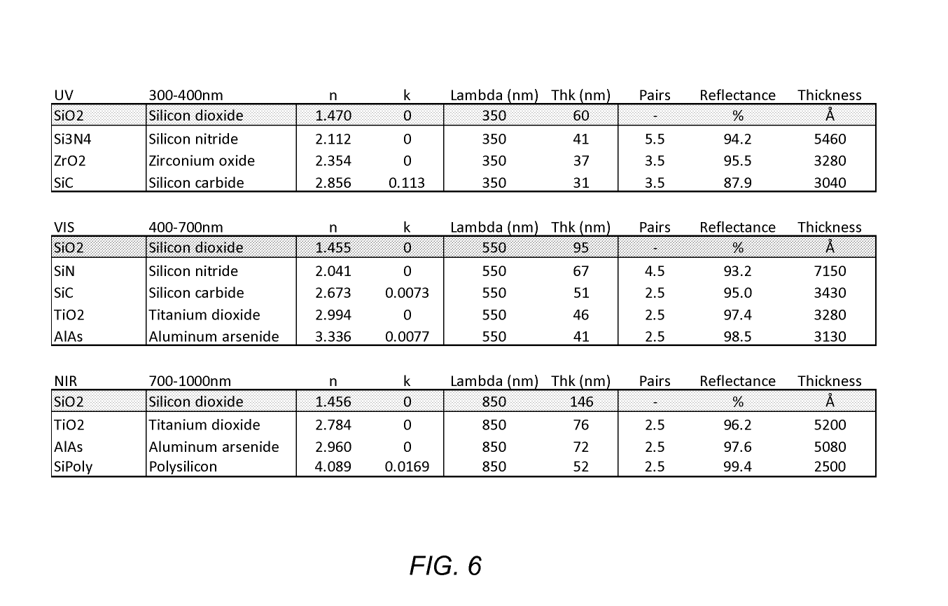

FIG. 6 is a table giving the lowest absorption (k), and greatest index difference (n) and percent reflectance of different materials for use in a distributed or Bragg dielectric mirror in the ultraviolet (UV), visible (VIS) and near infrared (NIR) wavelengths.

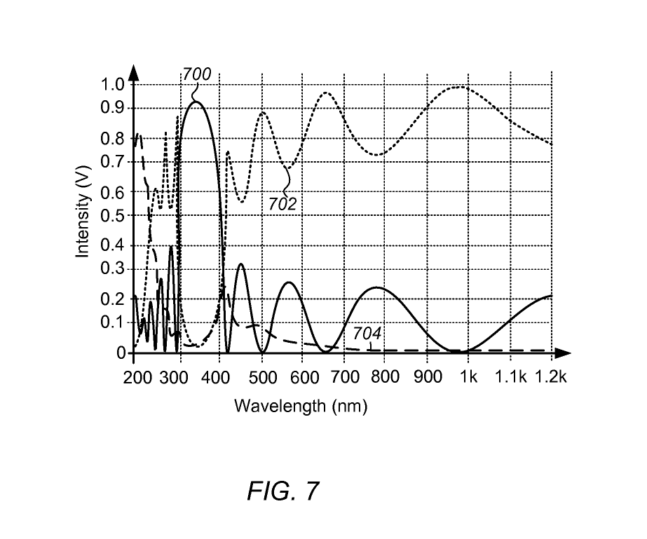

FIG. 7 is a graph illustrating the reflection 700, transmission 702 and absorption 704 of light in the ultraviolet (UV) wavelengths by a distributed or Bragg dielectric mirror including eleven (11) alternating layers of silicon-nitride (Si3N4) and silicon-dioxide (SiO₂). More specifically, the Bragg dielectric mirror includes six (6) layers of silicon-nitride (Si3N4) each having a thickness of about 41 nanometers (nm) interleaved with five (5) layers of silicon-dioxide (SiO₂) each having a thickness of about 60 nm, for a total thickness of 546 nm. Referring to FIG. 7 it is seen that this particular embodiment has a total reflection of 94.2% at a wavelength of 350 nm.

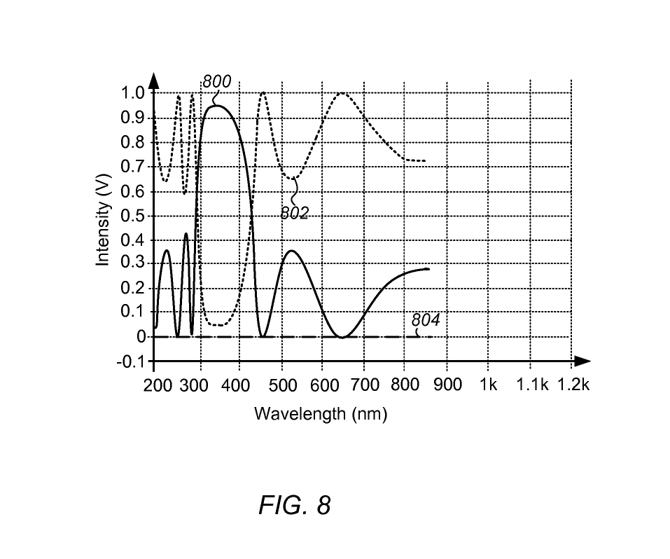

FIG. 8 is a graph illustrating the reflection 800, transmission 802 and absorption 804 of light in the ultraviolet (UV) wavelengths by a distributed or Bragg dielectric mirror including seven (7) alternating layers of a zirconium-oxide (ZrO₂) and silicon-dioxide (SiO₂). More specifically, the Bragg dielectric mirror includes four (4) layers of zirconium-oxide (ZrO₂) each having a thickness of about 37 nm interleaved with three (3) layers of silicon-dioxide (SiO₂) each having a thickness of about 60 nm, for a total thickness of 328 nm. Referring to FIG. 8 it is seen that this particular embodiment has a total reflection of 95.5% at a wavelength of 350 nm.

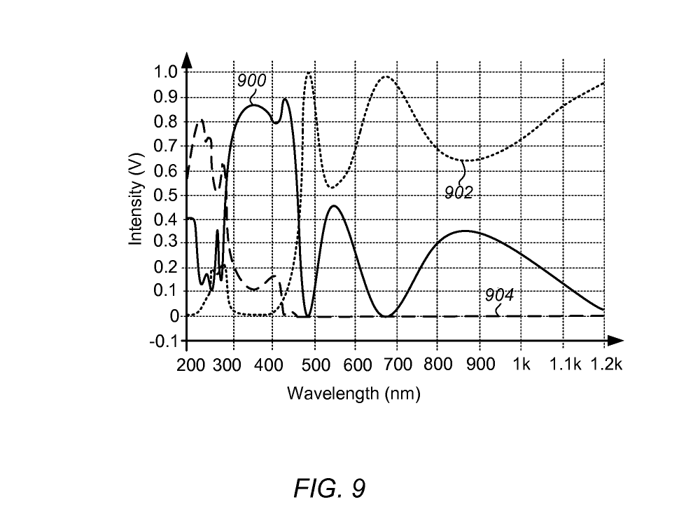

FIG. 9 is a graph illustrating the reflection 900, transmission 902 and absorption 904 of light in the ultraviolet (UV) wavelengths by a distributed or Bragg dielectric mirror including seven (7) alternating layers of a silicon-carbide (SiC) and silicon-dioxide (SiO₂). More specifically, the Bragg dielectric mirror includes four (4) layers of silicon-carbide (SiC) each having a thickness of about 31 nm interleaved with three (3) layers of silicon-dioxide (SiO₂) each having a thickness of about 60 nm, for a total thickness of 304 nm. Referring to FIG. 9 it is seen that this particular embodiment has a total reflection of 88% at a wavelength of 350 nm

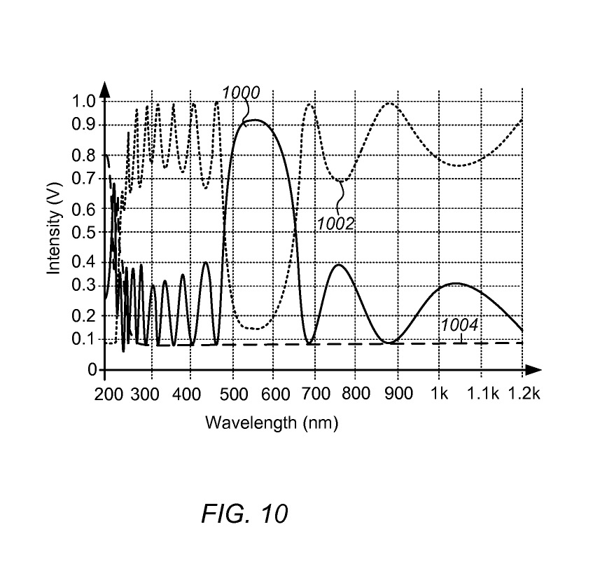

FIG. 10 is a graph illustrating the reflection 1000, transmission 1002 and absorption 1004 of light in the visible (VIS) wavelengths by a distributed or Bragg dielectric mirror including nine (9) alternating layers of silicon-nitride (Si3N4) and silicon-dioxide (SiO₂). More specifically, the Bragg dielectric mirror includes five (5) layers of silicon-nitride (Si3N4) each having a thickness of about 67 nm interleaved with four (4) layers of silicon-dioxide (SiO₂) each having a thickness of about 95 nm, for a total thickness of 715 nm. Referring to FIG. 10 it is seen that this particular embodiment has a total reflection of 93.2% at a wavelength of 550 nm.

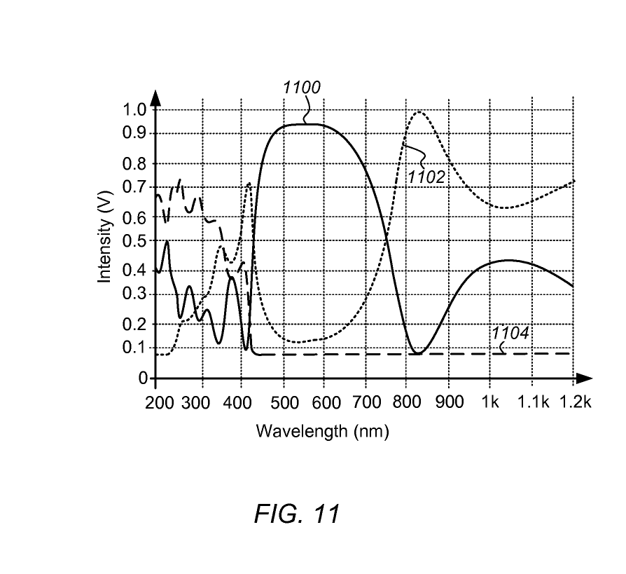

FIG. 11 is a graph illustrating the reflection 1100, transmission 1102 and absorption 1104 of light in the visible (VIS) wavelengths by a distributed or Bragg dielectric mirror including five (5) alternating layers of silicon-carbide (SiC) and silicon-dioxide (SiO₂). More specifically, the Bragg dielectric mirror includes three (3) layers of silicon-carbide (SiC) each having a thickness of about 51 nm interleaved with two (2) layers of silicon-dioxide (SiO₂) each having a thickness of about 95 nm, for a total thickness of 343 nm. Referring to FIG. 11 it is seen that this particular embodiment has a total reflection of 95% at a wavelength of 550 nm.

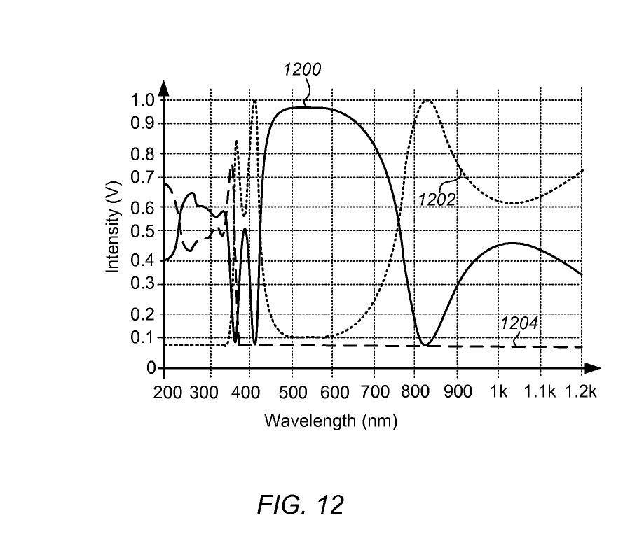

FIG. 12 is a graph illustrating the reflection 1200, transmission 1202 and absorption 1204 of light in the visible (VIS) wavelengths by a distributed or Bragg dielectric mirror including five (5) alternating layers of titanium-oxide (TiO₂) and silicon-dioxide (SiO₂). More specifically, the Bragg dielectric mirror includes three (3) layers of titanium-oxide (TiO₂) each having a thickness of about 46 nm interleaved with two (2) layers of silicon-dioxide (SiO₂) each having a thickness of about 95 nm, for a total thickness of 328 nm. Referring to FIG. 12 it is seen that this particular embodiment has a total reflection of 97.4% at a wavelength of 550 nm.

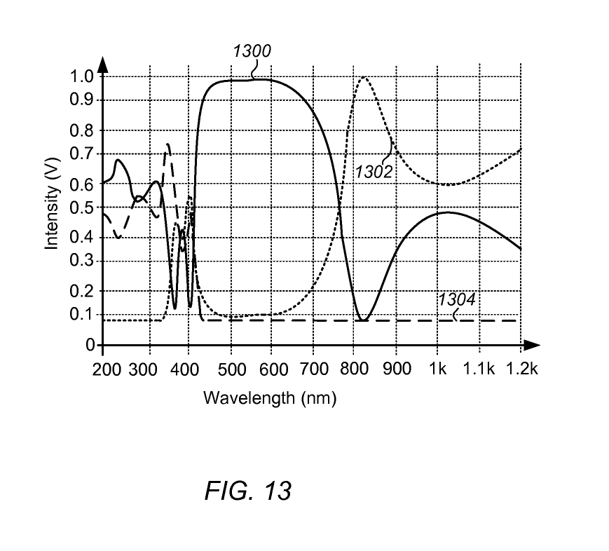

FIG. 13 is a graph illustrating the reflection 1300, transmission 1302 and absorption 1304 of light in the visible (VIS) wavelengths by a distributed or Bragg dielectric mirror including five (5) alternating layers of aluminum-arsenide (AlAs) and silicon-dioxide (SiO₂). More specifically, the Bragg dielectric mirror includes three (3) layers of aluminum-arsenide (AlAs) each having a thickness of about 41 nm interleaved with two (2) layers of silicon-dioxide (SiO₂) each having a thickness of about 95 nm, for a total thickness of 313 nm. Referring to FIG. 13 it is seen that this particular embodiment has a total reflection of 98.5% at a wavelength of 550 nm.

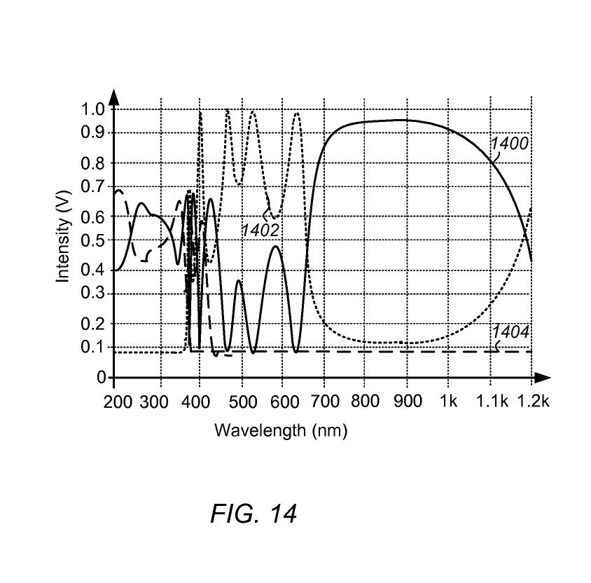

FIG. 14 is a graph illustrating the reflection 1400, transmission 1402 and absorption 1404 of light in the near infrared (NIR) wavelengths by a distributed or Bragg dielectric mirror including five (5) alternating layers of titanium-oxide (TiO₂) and silicon-dioxide (SiO₂). More specifically, the Bragg dielectric mirror includes three (3) layers of titanium-oxide (TiO₂) each having a thickness of about 76 nm interleaved with two (2) layers of silicon-dioxide (SiO₂) each having a thickness of about 146 nm, for a total thickness of 520 nm. Referring to FIG. 14 it is seen that this particular embodiment has a total reflection of 96.2% at a wavelength of 850 nm.

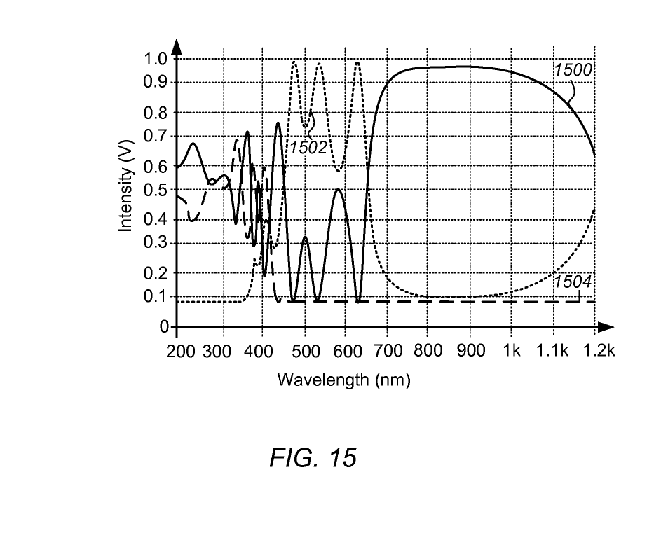

FIG. 15 is a graph illustrating the reflection 1500, transmission 1502 and absorption 1504 of light in the near infrared (NIR) wavelengths by a distributed or Bragg dielectric mirror including five (5) alternating layers of aluminum-arsenide (AlAs) and silicon-dioxide (SiO2). More specifically, the Bragg dielectric mirror includes three (3) layers of aluminum-arsenide (AlAs) each having a thickness of about 72 nm interleaved with two (2) layers of silicon-dioxide (SiO₂) each having a thickness of about 146 nm, for a total thickness of 508 nm. Referring to FIG. 15 it is seen that this particular embodiment has a total reflection of 97.6% at a wavelength of 850 nm.

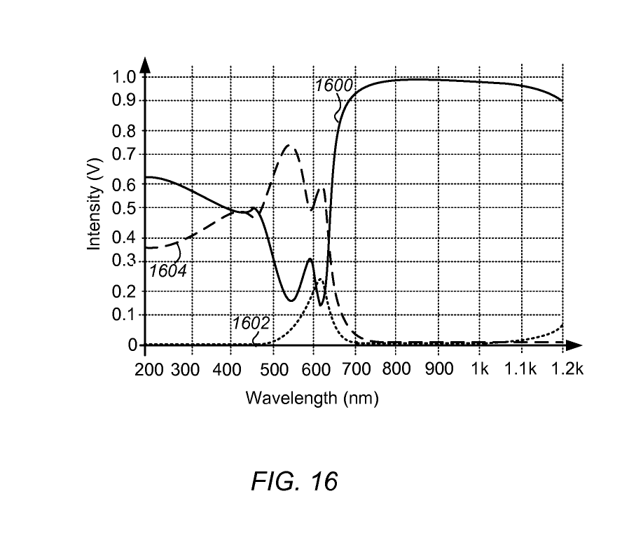

FIG. 16 is a graph illustrating reflection 1600, transmission 1602 and absorption 1604 of light in the near infrared (NIR) wavelengths by a distributed or Bragg dielectric mirror including five (5) alternating layers of polysilicon (SIPOLY) and silicon-dioxide (SiO2). More specifically, the Bragg dielectric mirror includes three (3) layers of polysilicon (SIPOLY) each having a thickness of about 52 nm interleaved with two (2) layers of silicon-dioxide (SiO₂) each having a thickness of about 146 nm, for a total thickness of 448 nm. Referring to FIG. 16 it is seen that this particular embodiment has a total reflection of 99.4% at a wavelength of 850 nm.

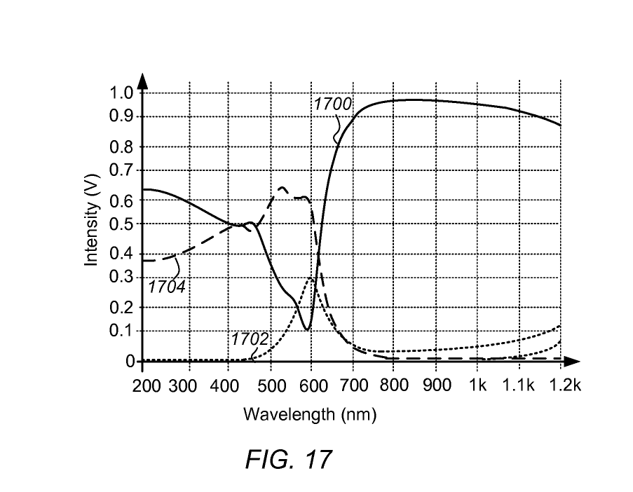

FIG. 17 is a graph illustrating the reflection 1700, transmission 1702 and absorption 1704 of light in the near infrared (NIR) wavelengths by a distributed or Bragg dielectric mirror including three (3) alternating layers of polysilicon (SIPOLY) and silicon-dioxide (SiO2). More specifically, the Bragg dielectric mirror includes two (2) layers of polysilicon (SIPOLY) each having a thickness of about 52 nm interleaved with a single layer of silicon-dioxide (SiO₂) having a thickness of about 146 nm, for a total thickness of 250 nm. Referring to FIG. 17 it is seen that this particular embodiment has a total reflection of 96.7% at a wavelength of 850 nm.

In another aspect, the present disclosure is directed to a laser processing system including a number of MEMs based optical modulators, each including a number of dielectric mirrors or reflectors, grouped or ganged together in a one dimensional (1D) or two-dimensional (2D) array to create a high power spatial light modulator (SLM).

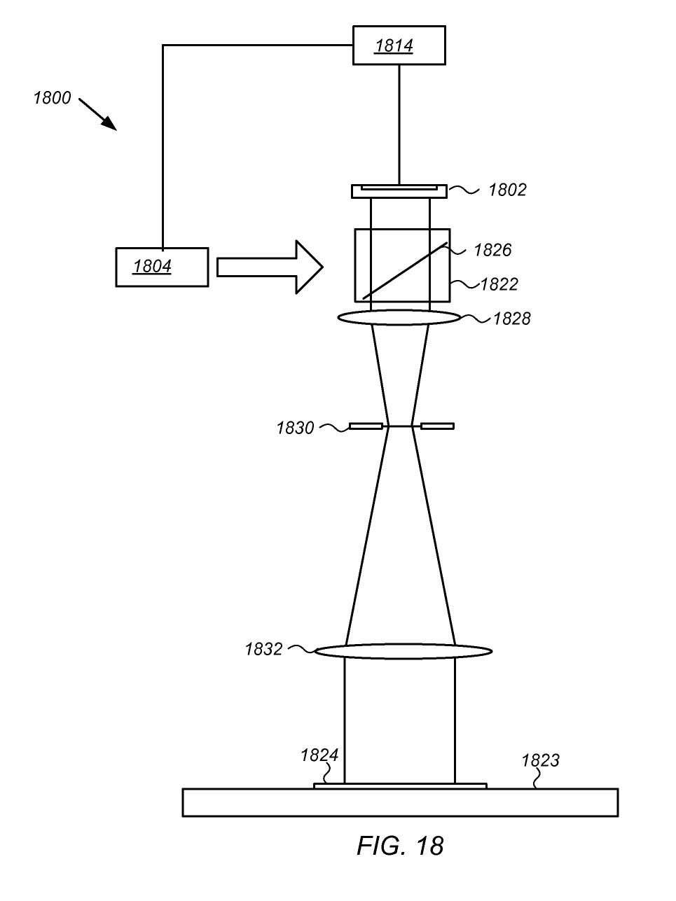

An embodiment of a laser processing system including a MEMs based SLM including a number of dielectric mirrors or reflectors formed thereon to modulate a beam of light generated by a laser will now be described with reference to FIG. 18. FIG. 18 is a schematic block diagram of a laser processing system 1800 including a MEMs based SLM 1802, a high powered, Nano-, pico- or femto-second laser 1804, imaging optics and illumination optics, a controller 1814 to provide voltages to drive the MEMS based SLM and control operation of the laser 1804 and a workpiece support 1823 to hold a target workpiece 1824.

Generally, the illumination optics include a number of elements including lenses, mirrors and prisms, designed to transfer a light beam from the laser 1804, such as an Ultra Violet laser, to the MEMs based SLM 1802 to illuminate an area substantially equal to that of the reflective surface of the MEMS based SLM. In the embodiment shown, the illumination optics include a polarizing beam splitter (PBS) 1822, which reflects light having a first polarization onto the MEMs based SLM 1802, and transmits the light having a second polarization from the MEMs based SLM towards a target wafer or workpiece 1824 through the imaging optics. For example, the PBS 1822 can be adapted to reflect light having a Transverse-Electric (TE) polarization towards the MEMs based SLM 1802, and to transmit light having a Transverse-Magnetic (TM) polarization toward the target workpiece 1824. The light that is initially directed toward the MEMs based SLM 1802 by the PBS 1822 in the TE state will pass twice through a quarter-wave plate (QWP) 1826, thus converting it to TM polarization and allowing to pass through the PBS and on to the imaging optics that follow.

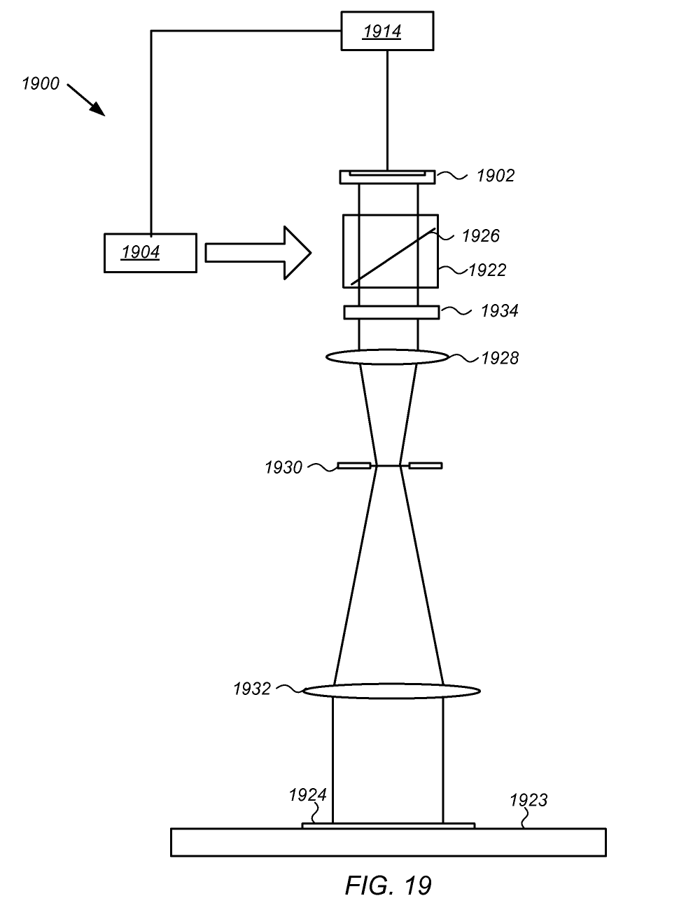

Another embodiment of a laser processing system using phase modulation and including a MEMs based SLM including a number of dielectric mirrors or reflectors formed thereon to modulate a beam of light generated by a laser will now be described with reference to FIG. 19. FIG. 19 is a schematic block diagram of a laser processing system 1900 similar to that of FIG. 18 and further includes an element or elements, such as a crystal 1934, to vary an intensity of phase modulated light or convert phase modulated light to an intensity modulation.

In accordance with one embodiment of the invention of the present disclosure, and similar to the laser processing system 1800 of FIG. 18, the laser processing system 1900 further includes in addition to a high-power handling MEMs based SLM 1902, a high powered, Nano-, pico- or femto-second laser 1904, imaging optics and illumination optics, a controller 1914 to provide voltages to drive the MEMS based SLM and control operation of the laser 1904 and a workpiece support 1923 to hold a target workpiece 1924.

Generally, the illumination optics include a number of elements including lenses, mirrors and prisms, designed to transfer a light beam from the laser 1904, such as an Ultra Violet laser, to the MEMs based SLM 1902 to illuminate an area substantially equal to that of the reflective surface of the MEMS based SLM. In the embodiment shown, the illumination optics include a PBS 1922, which reflects light having a first polarization onto the MEMs based SLM 1902, and transmits the light having a second polarization from the MEMs based SLM towards a target wafer or workpiece 1924 through the imaging optics. For example, the PBS 1922 can be adapted to reflect light having a TE polarization towards the MEMs based SLM 1902, and to transmit light having a TM polarization toward the target workpiece 1924. The light that is initially directed toward the MEMs based SLM 1902 by the PBS 1922 in the TE state will pass twice through QWP 1926, thus converting it to TM polarization and allowing to pass through the PBS and on to the imaging optics that follow.

As shown, the imaging optics can include magnification and filtering elements, such as a FT lens 1928 to focus and direct light from the MEMs based SLM 1902 onto a FT filter, a FT filter 1930 to select the 0th order modulated light, and a second, larger Inverse FT lens 1932 to enlarge the image generated by MEMs based SLM and project it onto the target workpiece 1924.

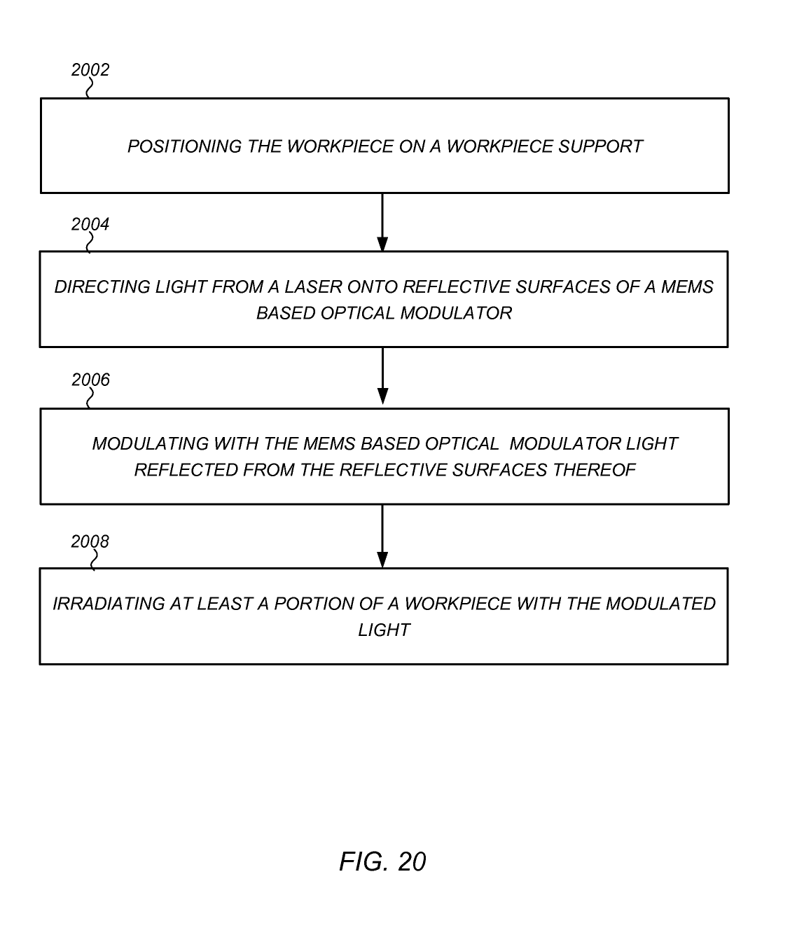

A method for processing a workpiece using the laser processing system of FIG. 18 or 19 will now be described with reference to the flow chart of FIG. 20. Referring to FIG. 20, the method begins with positioning the workpiece on a workpiece support. (step 2002) Next, light or a light beam from a laser is directed onto dielectric mirrors or reflectors of a MEMs based SLM. (step 2004) The SLM can be either a diffractive SLM or a phase modulating SLM. The light reflected from the dielectric mirror of the MEMs based diffractive SLM reflective is modulated thereby (step 2006), and at least a portion of a workpiece with the modulated light irradiated with the modulated light. (step 2008) As noted above the processing can include sintering or ablating the workpiece for a number of different applications including cutting, marking, engraving, printing, testing and measuring.

Thus, embodiments of a laser processing system including a MEMs based optical modulators with dielectric mirrors have been described. Although the present disclosure has been described with reference to specific exemplary embodiments, it will be evident that various modifications and changes may be made to these embodiments without departing from the broader spirit and scope of the disclosure. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of one or more embodiments of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Reference in the description to one embodiment or an embodiment means that a particular feature, structure, or characteristic described in connection with the embodiment is included in at least one embodiment of the circuit or method. The appearances of the phrase one embodiment in various places in the specification do not necessarily all refer to the same embodiment.

What is claimed is:

1. A laser processing system comprising:
a workpiece support;
a laser;
a MEMs based reflective, optical modulator to modulate a beam generated by the laser; and
imaging optics to direct modulated light from the optical modulator onto a workpiece on the workpiece support,
wherein the optical modulator comprises a number of surfaces with dielectric mirrors formed thereon to modulate the beam generated by the laser.

2. The system of claim 1 wherein the dielectric mirrors comprise Bragg mirrors including a stack of layers having different optical characteristics.

3. The system of claim 2 wherein the optical modulator is a ribbon-type optical modulator comprising a plurality of ribbons including electrostatically deflectable ribbons supported above a substrate, each of the on ribbons having a dielectric mirror formed thereon to form a dynamically adjustable diffraction grating.

4. The system of claim 2 wherein the optical modulator is a planar light valve (PLV™) comprising a 2-dimensional, close-packed array of diffractors each comprising a portion of a static face plate and a movable actuator, the static face plate and each of the movable actuators include a dielectric mirror formed thereon.

5. The system of claim 4 wherein the dielectric mirrors are mechanically isolated from the movable actuator of the PLV™.

6. The system of claim 2 wherein thicknesses of layers in the stack of layers are selected to match a center wavelength of the laser.

7. The system of claim 2 wherein the Bragg mirrors are adapted to reflect light in ultraviolet (UV) wavelengths of from about 300 to about 400 nm.

8. The system of claim 2 wherein the Bragg mirrors are adapted to reflect light in visible (VIS) wavelengths of from about 400 to about 700 nm.

9. The system of claim 2 wherein the Bragg mirrors are adapted to reflect light in near infrared (NIR) wavelengths of from about 700 to about 2000 nm.

10. The system of claim 2 wherein layers in the stack of layers comprise one or more reflective layers of polysilicon, silicon-oxide, titanium oxide, silicon-carbide, aluminum-arsenide, Zirconium oxide and Titanium dioxide.

11. The system of claim 10 wherein layers in the stack of layers further comprises one or more light absorbing layers underlying the reflective layers.

12. The system of claim 1 wherein optical modulator is a diffractive optical modulator.

13. The system similar to claim 1 wherein the optical modulator is a phase modulator.

14. A method for processing a workpiece using laser processing system, the method comprising:
positioning the workpiece on a workpiece support;
directing light from a laser onto reflective surfaces of MEMs based optical modulators; ganged together to create a high powered spatial light modulator (SLM);
modulating with the SLM light reflected from the reflective surfaces thereof; and
irradiating at least a portion of a workpiece with the modulated light,
wherein the reflective surfaces comprise dielectric mirrors.

15. The method of claim 14 wherein the reflective surfaces comprise Bragg mirrors including a stack of layers having different optical characteristics.

16. A high powered spatial light modulator (SLM) comprising a plurality of MEMs based optical modulators each comprising a number of surfaces with dielectric mirrors formed thereon to modulate a beam of light generated by a laser.

17. The SLM of claim 16 wherein the dielectric mirrors comprise Bragg mirrors including a stack of layers having different optical characteristics.

18. The SLM of claim 17 wherein in the stack of layers further comprises one or more light absorbing layers underlying the reflective layers.

19. The SLM of claim 16 wherein the MEMs based optical modulators are ribbon-type optical modulators comprising a plurality of ribbons including electrostatically deflectable ribbons supported above a substrate, each of the on ribbons having a dielectric mirror formed thereon to form a dynamically adjustable diffraction grating.

20. The SLM of claim 16 wherein the MEMs based optical modulators are planar light valves (PLV™), arranged in a 2-dimensional, close-packed array of PLVs™, and wherein each PLV™ comprises a portion of a static face plate and a movable actuator, the static face plate and each of the movable actuators include a dielectric mirror formed thereon.
